(19) United States
(12) Patent Application Publication
(10) Pub. No.: US 2020/0245114 A1
(43) Pub. Date: Jul. 30, 2020

(54) A CONTROLLER AND A METHOD FOR CONTROLLING A LIGHTING DEVICE OF A PEOPLE TRANSPORTATION OBJECT

(71) Applicant: SIGNIFY HOLDING B.V., EINDHOVEN (NL)

(72) Inventor: PETRUS ANTONIUS VERBEEK, DEURNE (NL)

(21) Appl. No.: 16/756,587

(22) PCT Filed: Oct. 8, 2018
(86) PCT No.: PCT/EP2018/077267

§ 371 Date: Apr. 16, 2020

(30) Foreign Application Priority Data
Oct. 16, 2017 (EP) 17196604.7

(51) Int. Cl. H04W 4/42; H04B 10/116; H04W 4/029; H04W 64/00; H04W 92/08; H04W 88/04; G08G 1/00

(52) U.S. Cl. CPC H04W 4/42; H04B 10/116; H04W 4/029; G08G 1/205; H04W 92/08; H04W 88/04; H04W 64/003

(57) ABSTRACT

A controller for controlling a lighting device of a people transportation object is disclosed. The people transportation object is configured to traverse a plurality of locations. The controller comprises: a receiver configured to obtain location information indicative of a current location, an upcoming location and/or a destination location of the people transportation object, and a processor configured to control the lighting device such that the light output of the lighting device comprises an embedded code indicative of the current location, the upcoming location and/or the destination location of the people transportation object.

### FIELD OF THE INVENTION

The invention relates to a controller for controlling a lighting device of a people transportation object. The invention further relates to a people transportation object comprising the controller.

The invention further relates to a system for communicating a current location, an upcoming location or a destination location of a people transportation object to a user.

The invention further relates to a method of controlling a lighting device of a people transportation object. The invention further relates to a computer program product for performing the method.

### BACKGROUND

Visible light communication (VLC) is a is a data communication technology which uses visible light for communicating data to (mobile) devices. The data is embedded in the light by providing variations in the light output of one or more light sources, such as LED light sources. VLC (also known as coded light) is currently being used for (indoor) positioning and navigation purposes. In VLC-based (indoor) positioning and navigation systems, each light source emits a unique code which is associated with a location in an (indoor) space. A mobile device, such as a smartphone, may detect the light, retrieve the unique code and retrieve the location associated with that unique code.

US 20170115125 A1 discloses determining a first code with a management system for a meeting between a vehicle and a user at a meeting location. A device aboard an autonomous vehicle emits a light signal based on the first code when it is located at the meeting location, which light signal may be detected by a camera of a user's device.

### SUMMARY OF THE INVENTION

The inventors have realized that when a light source does not have a fixed position relative to a space wherein a VLC positioning system is installed, the light source cannot be used for positioning purposes. An example of such a light source is a light source in an elevator. In current VLC positioning systems, light sources in the elevator are not part of the VLC positioning system.

It is therefore an object of the present invention to integrate people transportation objects, such as elevators and vehicles, into a VLC-based positioning system.

According to a first aspect of the present invention, the object is achieved by a people transportation object configured to traverse a plurality of locations, the people transportation object comprising:

a lighting device for emitting light inside the people transportation object, and

a controller comprising:

a receiver configured to receive location information indicative of a current location of the people transportation object, and

a processor configured to determine the current location of the people transportation object based on the location information, and to control the lighting device such that the light output of the lighting device comprises an embedded code indicative of the current location to inform a user inside the people transportation object about the current location of the people transportation object.

The processor of the controller may be configured to embed the current location of the people transportation object in the light emitted by the lighting device inside the people transportation object to inform a user (operating a mobile device for receiving the embedded code) inside the people transportation object about the current location of the people transportation object. The processor may, for example, continuously update the code embedded in the light as a function of the current location of the people transportation object. This is beneficial, because it enables a mobile device located in the people transportation object to continuously determine its location. Alternatively, the processor may update the code embedded in the light as a function of the current location in discrete steps, for example after a certain distance, at certain intermediate locations, after a certain period of time, etc. The processor may be configured to embed a code in the light which is indicative of an upcoming location of the trajectory which is traversed by the people transportation object. The processor may be configured to embed a code in the light which is indicative of a (user defined) destination location of the people transportation object. The destination location may be the destination of a user located in the people transportation object. This may be beneficial when intermediate locations between a starting location and the upcoming/destination location are irrelevant for a user or a mobile device travelling in the people transportation object.

The receiver may be further configured to obtain an upcoming location and/or a destination location of the people transportation obejct, and the processor may be further configured to control the lighting device such that the light output of the lighting device comprises an embedded code indicative of the upcoming location and/or the destination location.

The receiver may be further configured to receive the destination location from a user. The user may, for example, provide input indicative of the destination location (e.g. a floor level, a station, etc.) via a control panel, via a user interface of a mobile device, via a voice command, etc. Additionally or alternatively, the destination location may be communicated to the controller automatically by a mobile device (e.g. a smartphone). This is beneficial, because it enables the processor to determine which code to embed in the light emitted by the lighting device when the people transportation object moves towards/approaches/arrives at the destination location.

The processor may be coupled to a detector comprised in the people transportation object configured to detect if the user has entered the people transportation object, and the processor may be configured to:

determine a starting location of the people transportation object when the user has entered the people transportation object,

control, when the people transportation object is located in between the starting location and the destination location or located at the destination location, the lighting device such that the embedded code is indicative of the destination location. This may be beneficial when intermediate locations between a starting location and the destination location are irrelevant for a user travelling in the people transportation object. For instance, when a user enters an elevator, his destination floor level may be more relevant than intermediate floor levels.

The people transportation object may comprise a plurality of lighting devices, and the receiver may be configured to receive a signal from a mobile device indicative of that the mobile device has received a first code comprised in the light output of a first lighting device of the plurality of lighting devices, and the processor may be further configured to control the first lighting device such that the light output of the first lighting device comprises the embedded code indicative of the destination location. This embodiment is beneficial when multiple users are present in the people transportation object, because only a lighting device of which the code is being received by a mobile device is controlled such that it emits the code representative of the destination location of that user. This way, other users do not receive the destination location of the user when they are located at other lighting devices.

The people transportation object may comprise a plurality of lighting devices, and the detector may be further configured to determine a user location of the user in the people transportation object. The processor may be further configured to:

obtain locations of a plurality of lighting devices comprised in the people transportation object,

select one or more lighting devices from the plurality of lighting devices of which the locations correspond to the user location, and

control the one or more selected lighting devices such that the embedded code is indicative of the destination location. This embodiment is beneficial when multiple users are present in the people transportation object, because only lighting devices that are located at a location that corresponds to the location of the user are controlled such that they emit the code representative of the destination location of that user. This way, other users do not receive the destination location of the user when they are located at other lighting devices.

The processor may be further configured to control the lighting device such that the embedded code is further indicative of travel information. The travel information may, for example, be received from a people transportation object system (e.g. an elevator system, a vehicle control system, etc.). The travel information may, for example, relate to a current status of the people transportation object (e.g. movement status, delay, estimated time of arrival at the next/destination location, etc.). This is beneficial, because the travel information is communicated to a user via a mobile device that receives the light emitted by the lighting device.

The processor may be further configured to receive an indication that the travel information is being communicated via a public user interface (such as an elevator panel, a loudspeaker, etc.). The processor may be further configured to control the lighting device such that the embedded code is further indicative of travel information (only) when the travel information is being communicated via the public user interface. According to a second aspect of the present invention, the object is achieved by a controller for use in the people transportation object, the controller comprising:

a receiver configured to obtain location information indicative of a current location of the people transportation object, and

a processor configured to determine the current location of the people transportation object based on the location information, and to control the lighting device of the transportation object such that the light output of the lighting device comprises an embedded code indicative of the current location of the people transportation object to inform a user inside the people transportation object about the current location of the people transportation object. The people transportation object may be an elevator, and the location information may be indicative of a floor level of the people transportation object. Additionally, the location information may be further indicative of a location of the elevator in a building. This is beneficial, because it enables a mobile device to determine its location in relation to the building three-dimensionally.

The people transportation object may be a vehicle (e.g. a train, a (self-driving) vehicle, an autonomous aerial vehicle, etc.). The location information may for example be indicative of a current (global) position of the vehicle, or a current station/next station/destination of the vehicle.

According to a third aspect of the present invention, the object is achieved by a system for communicating a current location, an upcoming location or a destination location of a people transportation object to a user inside the people transportation object, the system comprising:

the people transportation object according to the people transportation object of any above-mentioned embodiment, and

a mobile device comprising a light detector configured to detect the code embedded in the light output of the lighting device, and a processing unit configured to retrieve the current location, the upcoming location and/or the destination location of the people transportation object from the code. This enables the mobile device to determine its current location based on the current location. Alternatively, this enables the mobile device to already determine the upcoming location and/or the destination location of the people transportation object.

The mobile device may further comprise a user interface, and the processing unit may be further configured to render the current location, the upcoming location or the destination location on the user interface. This is advantageous because the current location, the upcoming location or the destination location is communicated to the user via the user interface.

According to a fourth aspect of the present invention, the object is achieved by a method of controlling a lighting device for emitting light inside a people transportation object, the people transportation object being configured to traverse a plurality of locations, the method comprising:

receiving location information indicative of a current location of the people transportation object,

determining the current location of the people transportation object based on the location information, and

controlling the lighting device such that the light output of the lighting device comprises an embedded code indicative of the current location of the people transportation object to inform a user inside the people transportation object about the current location of the people transportation object.

According to a fifth aspect of the present invention, the object is achieved by a computer program product for a computing device, the computer program product comprising computer program code to perform the above-mentioned method when the computer program product is run on a processing unit of the computing device.

It should be understood that the claimed people transportation object, system, method and computer program product may have similar and/or identical embodiments and advantages as the claimed controller.

### BRIEF DESCRIPTION OF THE DRAWINGS

The above, as well as additional objects, features and advantages of the disclosed systems, devices and methods will be better understood through the following illustrative and non-limiting detailed description of embodiments of devices and methods, with reference to the appended drawings, in which:

FIG. 1 shows schematically an embodiment of a system for controlling a lighting device of a people transportation object;

FIG. 2 shows schematically an embodiment of an elevator comprising a controller for controlling a lighting device; and

FIG. 3 shows schematically an embodiment of a train wagon comprising a controller for controlling a lighting device.

All the figures are schematic, not necessarily to scale, and generally only show parts which are necessary in order to elucidate the invention, wherein other parts may be omitted or merely suggested.

### DETAILED DESCRIPTION OF EMBODIMENTS

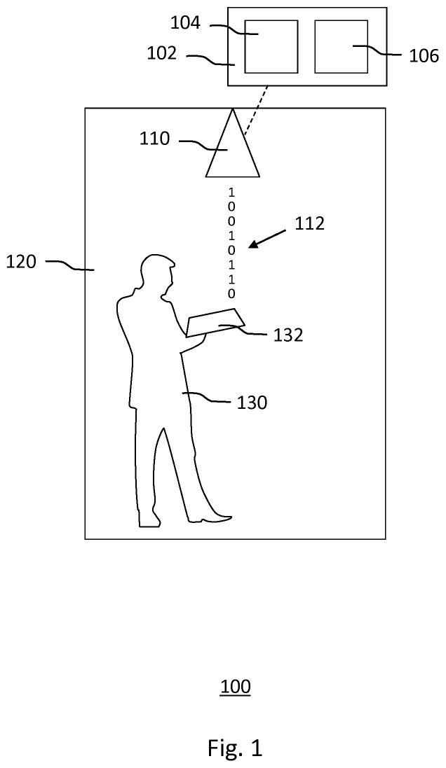

FIG. 1 shows schematically an embodiment of a system 100 for controlling a lighting device 110 of a people transportation object 120. The system 100 comprises the people transportation object 120, a controller 102, the lighting device 110 and a mobile device 132. The controller 102 is configured to control the lighting device 110. The controller 102 comprises a receiver 106 configured to obtain location information indicative of a current location, an upcoming location and/or a destination location of the people transportation object 120. The controller 102 further comprises a processor 104 configured to control the lighting device 110 such that the light output of the lighting device comprises an embedded code 112 indicative of the current location, the upcoming location and/or the destination location of the people transportation object.

The people transportation object 120 is configured to transport people and to traverse a plurality of locations. Examples of people transportation objects 120 include but are not limited to vehicles such as trains, metros, subways, trams, (autonomous) cars, trucks, elevators, etc.

The people transportation object 120 comprises at least one lighting device 110 inside the people transportation 120 comprising one or more light sources (e.g. LED or OLED light sources) configured to emit light inside the people transportation object 120 comprising an embedded code 112.

The people transportation object 120 may further comprise the controller 102. The controller 102 may be comprised in or coupled to a central control system of the people transportation object 120. The receiver 106 of the controller 102 is configured to obtain location information indicative of a current location of the people transportation object 120. The receiver 106 may receive the location information from the central control system of the people transportation object 120, from a global or indoor positioning system, from a VLC-based positioning system, etc. The location information may comprise a set of coordinates indicative of the current location of the people transportation object 120. Alternatively, the location information may comprise a location description, for example indicating a floor level, a (train) station, a zone/area description, etc.

The processor 104 of the controller 102 is configured to control the lighting device 110 such that the light output of the lighting device 110 comprises an embedded code indicative of the current location, an upcoming location or a destination location of the people transportation object 120. The processor 104 may send control commands to a driver of the lighting device 110, which control commands comprise control instructions to control one or more light sources of the lighting device 110 such that code is indicative of the current location, the upcoming location or the destination location of the people transportation object 120. The code 112 may be created by any known principle of embedding a code in light, for example by controlling a time-varying, modulated current to one or more light sources of the lighting device 110 to produce variations in the light output, by modulating the amplitude and/or the duty-cycle of the light pulses, etc.

The processor 104 may be configured to embed the current location of the people transportation object in the code 112 emitted by the lighting device 110. The processor 104 may, for example, continuously update the code 112 embedded in the light as a function of the current location (e.g. a GPS location, an indoor location, a height position, etc.) of the people transportation object 120. The mobile device 132 located in the people transportation object 120 may be continuously updated on the (exact) location of the people transportation device 120, and therewith continuously updated on its own location. Alternatively, the processor 104 may update the code 112 embedded in the light as a function of the current location in discrete steps. The processor 104 may for example update the code 112 each time a certain distance has been traversed by the people transportation object 120 (e.g. every 100 meter, every meter, etc.). Additionally or alternatively, the processor 104 may update the code 112 (only) at predefined locations, such as stations or floor levels. Additionally or alternatively, the processor 104 may for example update the code 112 after each predefined time interval (e.g. every millisecond, second, minute, etc.).

The processor 104 may be configured to embed a code 112 indicative of an upcoming location in the light output of the lighting device 110. The upcoming location may be a next location on the trajectory which is traversed by the people transportation object 120. The upcoming location may, for example, be a next floor level, a next station, a next stop, etc. The upcoming location may be received by the receiver 106. The upcoming location may be received via a mobile device, such as the mobile device 132, an elevator panel, a central people transportation control system, etc.

The processor 104 may be configured to embed a code 112 indicative of destination location in the light output of the lighting device 110. The destination location may be received by the receiver 106, or indirectly via another input channel of the processor 104. The destination location may be received from a user 130 directly, for example based on a voice command of the user 130 (e.g. “take me to floor 5” or “take me to Main Street”). Alternatively, the destination location may be received from a mobile device 132, an elevator panel, etc. The destination location may for example be based on a user input or based on an automatically generated input from, for example, a navigation system of the mobile device 132.

The mobile device 132 comprises a light detector (not shown) configured to detect the code 112 embedded in the light output of the lighting device 110. The light detector may for example be a photodiode or a camera. The mobile device 132 further comprises a processing unit (not shown) configured to retrieve the current location, the upcoming location or the destination location of the people transportation object 120 from the code 112.

The mobile device 132 may further comprise a user interface (not shown). The processing unit of the mobile device 132 may be further configured to render the current location, the upcoming location or the destination location on the user interface. The user interface may, for example, be a display for displaying the location visually, a loudspeaker for providing the location auditory, etc.

The processor 104 may be coupled to a detector (not shown) configured to detect if the user has entered the people transportation object 120. The detector may be comprised in the people transportation object 120. The detector may, for example, be a presence detector configured to detect the presence of the user. Alternatively, the detector may comprise a transceiver configured to communicate with the mobile device 132, and determine the presence of the user when the mobile device 132 has established a connection with the transceiver. Alternatively, the detector may comprise a transceiver/receiver, and a light detector of the mobile device may be configured to detect the code 112 emitted by the lighting device 110, and the mobile device 132 may transmit a message to the transceiver/receiver indicating that the code 112 has been/is being detected. This enables the detector to determine that the user is present in the people transportation object 120.

Upon receiving the destination location, the processor 104 may determine a starting location of the people transportation object 120 when the user has entered the people transportation object 120. The starting location may, for example, be a GPS location, a certain indoor location, a certain floor level, a certain station, etc. The processor 104 may further control the lighting device 110 such that the embedded code 112 is indicative of an upcoming location, such as a next floor level, a next station, etc., or the destination location. The processor 104 may determine, based on the location information indicative of the current location, received by the receiver 106, that the people transportation object 120 has left the starting location and is on its way to the upcoming location or to the destination location. The processor 104 may update the code 112 embedded in the light output of the lighting device 110 to communicate the upcoming or the destination location to the mobile device 132 that is receiving the code 112.

The people transportation object may comprise a plurality of lighting devices, for example a first lighting device and a second lighting device. The mobile device 132 may detect a first code emitted by the first lighting device. The first code may (initially) comprise a lighting device identifier, and the processing unit of the mobile device 132 may identify the first lighting device based on the lighting device identifier. The mobile device 132 may comprise a transmitter (not shown) configured to transmit a signal, indicative of that the mobile device 132 has received the first code, to the receiver 106 of the controller 102. The receiver 106 may be configured to receive the signal from the mobile device 132, whereupon the processor 104 may determine, based on the signal, that the mobile device 132 is located at the first lighting device. The processor 104 may be further configured to control the first lighting device such that the light output of the first lighting device comprises an embedded code indicative of the destination location of the user 130 operating the mobile device 132.

Additionally or alternatively, the processor 104 may be configured to obtain locations of the lighting devices and a location of the user 130 (or the mobile device 132), and control only lighting devices that are located at the user's location according to the user's 130 destination location. The detector may for example be configured to determine a user location of the user 130 in the people transportation object 120. The detector may receive the position of the user 130 from a positioning system comprised in the people transportation object 120. Alternatively, the detector may comprise a transceiver configured to communicate with the mobile device 132, and determine the position of the mobile device 132 based on, for example, a received signal strength or time of flight of signals transmitted between the mobile device 132 and the transceiver. The processor 104 may be configured to obtain (for example via the receiver 106) locations of a plurality of lighting devices comprised in the people transportation object 120, and select one or more lighting devices from the plurality of lighting devices of which the locations correspond to the user location. The processor 104 may then control the one or more selected lighting devices such that the embedded code is indicative of the destination location.

The processor 104 may be further configured to obtain travel information. The travel information may, for example, be received by the receiver 106. The travel information may for example be received from a people transportation control system (e.g. an elevator control system, a central train system, a navigation system, etc.). The travel information may, for example, relate to an estimated time of arrival at an upcoming/destination location, relate to travel delay, etc., and the processor 104 may be further configured to control the lighting device 110 such that the embedded code 112 is further indicative of the travel information. The light detector of the mobile device 132 may receive the embedded code 112, and the processing unit may be configured to retrieve the travel information from the embedded code 112. The processing unit may further communicate the travel information to a user 130 operating the mobile device 132 via the user interface of the mobile device 132.

The processor 104 may be further configured to receive an indication that the travel information is being communicated via a public user interface, such as an elevator panel, a loudspeaker, a public display, etc. The processor 104 may be further configured to control the lighting device 110 such that the embedded code 112 is further indicative of travel information (only) when the travel information is being communicated via the public user interface.

The controller 102 may be coupled to a VLC-based positioning system configured to communicate via a visible light communication protocol, and the processor may be configured to control the lighting device 110 according to the same visible light communication protocol. This enables a smooth handover of the location information between the visible light positioning system (which may, for example, provide positioning information outside the people transportation object 120) and the people transportation object 120, either when the user 130 enters the people transportation object 120 or when the user exits the people transportation object 120.

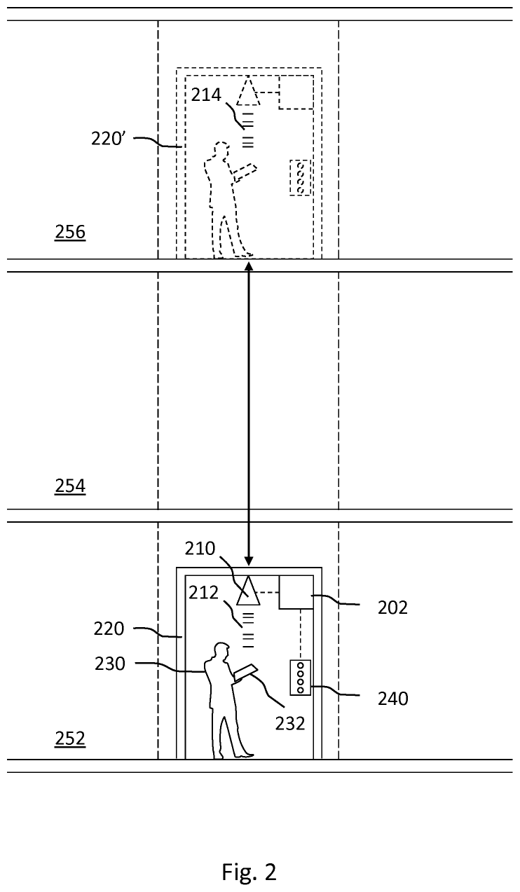

FIG. 2 shows schematically an embodiment of an elevator 220, 220′ comprising a controller 202 for controlling a lighting device 210. The controller 202 is configured to control the lighting device 210 such that it emits a code indicative of the elevator's 220 location. First, the elevator 220 may be located on the first floor 252. A user 230 may enter the elevator, whereupon the user 230 may provide a destination location for the elevator 220. The user 230 may select the destination location via an elevator control panel 240, or via a user interface of a mobile device 232 connected to the controller 202. Alternatively, the destination location may be automatically communicated from the mobile device 232 to the controller 202. In the example of FIG. 2, the destination location may be the third floor 256. The controller 202 may control the lighting device 210 such that it emits a first code 212 when the elevator 220 is located at the first floor 252, such that it emits a second code when the elevator 220 is located at the second floor 254 and such that it emits a third code 214 when the elevator 220 is located at the third floor 256. This enables the mobile device 232 receiving the codes to determine its location on floor level. In embodiments, the controller 202 may control the lighting device 210 such that it emits the third code 214 when the elevator leaves the first floor 252, because the intermediate location (the second floor 254) between the starting location (first floor 252) and the destination location (third floor 256) may be irrelevant for a user travelling directly to the third floor 256.

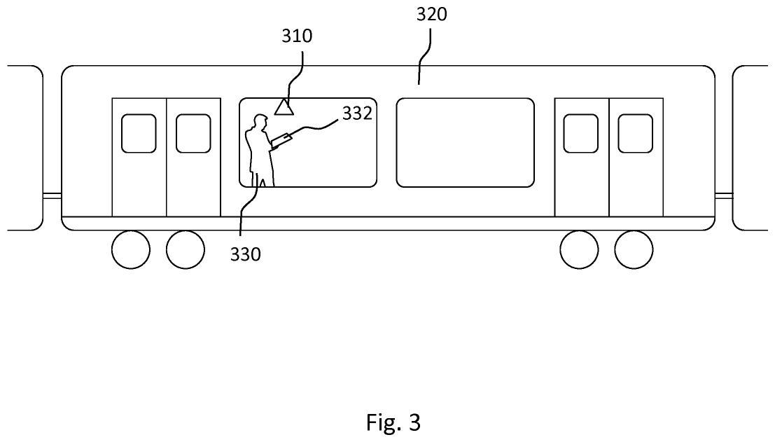

FIG. 3 shows schematically an embodiment of a train wagon 320 comprising a controller (not shown) for controlling a lighting device 310. The controller is configured to control the lighting device 310 such that it emits a code indicative of the train's or train wagon's location. A user 330 may enter the train wagon 320, whereupon the user 330 may provide a destination location, such as a specific train station. The user 330 may select the destination location via a train control panel, or via a user interface of a mobile device 332. Alternatively, the destination location may be automatically communicated from the mobile device 332 to the controller. In the example of FIG. 3, the destination location may be a next train station. The controller may control the lighting device 310 such that it emits a code based on the current location of the train to, for example, communicate a real-time location of the train to the mobile device 332. Additionally or alternatively, the controller may control the lighting device 310 such that it emits a code based on the destination location the specific train station) to, for example, ensure a proper handover between a VLC-based positioning system in the train and a second VLC-based positioning system at the specific train station. Additionally or alternatively, the controller may control the lighting device 310 such that it emits a code based on an upcoming location such as an upcoming train station to, for example, inform the mobile device 332 which station will be the next station.

The controller 102 may be further configured to control the lighting device 110 such that the code 112 comprised in the light output is further indicative of that the lighting device 110 is a repositionable lighting device. The mobile device 132 may receive the code 112 and the processing unit of the mobile device 132 may determine that the lighting device 110 is a repositionable lighting device based thereon. The processing unit of the mobile device 132 may determine an accuracy level based thereon. The processing unit of the mobile device 132 may, for example, determine that a location provided by a repositionable lighting device is less accurate than a location provided by a code in the light output of a fixed lighting device. The fixed lighting device may be part of a VLC-based positioning system and have a fixed location relative to the VLC-based system (i.e. a fixed location relative to the space wherein the VLC-based system has been installed), and the lighting device 110 may be configured to use the same protocol as the VLC-based positioning system. The processing unit of the mobile device 132 may be further configured, when a first code from a repositionable lighting device and a second code from a fixed lighting device are detected simultaneously, to determine the position of the mobile device 132 based on the code embedded in the light emitted by the fixed lighting device.

The processor 104 of the controller 102 may be further configured to run a computer program product comprising computer program code to execute a computer implemented method comprising: obtaining location information indicative of a current location, an upcoming location and/or a destination location of the people transportation object 120, and controlling the lighting device 110 such that the light output of the lighting device 110 comprises an embedded code 112 indicative of the current location, the upcoming location and/or the destination location of the people transportation object 120.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A people transportation object configured to traverse a plurality of locations, the people transportation object comprising:
a lighting device for emitting light inside the people transportation object, and
a controller comprising:
a receiver configured to receive location information indicative of a current location of the people transportation object, and
a processor configured to determine the current location of the people transportation object based on the location information, and to control the lighting device such that the light output of the lighting device comprises an embedded code indicative of the current location to inform a user inside the people transportation object about the current location of the people transportation object, the user operating a mobile device for receiving the embedded code.

2. The people transportation object of claim 1, wherein the receiver is further configured to obtain an upcoming location and/or a destination location of the people transportation object, and wherein the processor is further configured to control the lighting device such that the light output of the lighting device comprises an embedded code indicative of the upcoming location and/or the destination location.

3. The people transportation object of claim 2, wherein the receiver is further configured to receive the destination location from a user.

4. The people transportation object of claim 3, wherein the people transportation object comprises a detector configured to detect if the user has entered the people transportation object, and wherein the processor is coupled to the detector, and wherein the processor is configured to:
determine a starting location of the people transportation object when the user has entered the people transportation object, and
control, when the people transportation object is located in between the starting location and the destination location or located at the destination location, the lighting device such that the embedded code is indicative of the destination location.

5. The people transportation object of claim 4, wherein the people transportation object comprises a plurality of lighting devices, and wherein the receiver is configured to receive a signal from a mobile device indicative of that the mobile device has received a first code comprised in the light output of a first lighting device of the plurality of lighting devices, and wherein the processor is configured to control the first lighting device such that the light output of the first lighting device comprises the embedded code indicative of the destination location.

6. The people transportation object of claim 1, wherein the processor is further configured to control the lighting device such that the embedded code is further indicative of travel information.

7. The people transportation object of claim 6, wherein the processor is further configured to receive an indication that the travel information is being communicated via a public user interface, and wherein the processor is further configured to control the lighting device such that the embedded code is further indicative of travel information when the travel information is being communicated via the public user interface.

8. The people transportation object of claim 1, wherein the controller is coupled to a visible light positioning system configured to communicate via a visible light communication protocol, and wherein the processor is configured to control the lighting device according to the same visible light communication protocol.

9. The people transportation object of claim 1, wherein the people transportation object is an elevator, and wherein the location information is indicative of a floor level of the people transportation object.

10. The people transportation object of claim 9, wherein the location information is further indicative of a location of the elevator in a building.

11. The people transportation object of claim 1, wherein the people transportation object is a vehicle.

12. A system for communicating a current location to a user inside the people transportation object, the system comprising:
the people transportation object of claim 1, and
a mobile device comprising a light detector configured to detect the code embedded in the light output of the lighting device, and a processing unit configured to retrieve the current location from the code.

13. (canceled)

14. A method of controlling a lighting device for emitting light inside a people transportation object, the people transportation object being configured to traverse a plurality of locations, the method comprising:
receiving location information indicative of a current location of the people transportation object,
determining the current location of the people transportation object based on the location information, and
controlling the lighting device such that the light output of the lighting device comprises an embedded code indicative of the current location of the people transportation object to inform a user inside the people transportation object about the current location of the people transportation object, the user operating a mobile device for receiving the embedded code.

15. A computer program product for a computing device, the computer program product comprising computer program code to perform the method of claim 14 when the computer program product is run on a processing unit of the computing device.
